(19) United States
(12) Patent Application Publication
(10) Pub. No.: US 2026/0020057 A1
(43) Pub. Date: Jan. 15, 2026

(54) METHOD AND DEVICE FOR SELECTING RESOURCE

(71) Applicant: Beijing Xiaomi Mobile Software Co., Ltd., Beijing (CN)

(72) Inventor: Wensu ZHAO, Beijing (CN)

(21) Appl. No.: 18/997,760

(22) PCT Filed: Aug. 2, 2022
(86) PCT No.: PCT/CN2022/109812

§ 371 Date: Jan. 22, 2025

(51) Int. Cl. H04W 74/0808

(52) U.S. Cl. CPC H04W 74/0808

(57) ABSTRACT

A method and device for selecting a resource, the method including: a first UE receiving COT sharing information from a second UE; determining, based on the COT sharing information, whether the first UE is capable of sharing a COT indicated in the COT sharing information; determining, through resource aware, a candidate resource set within a resource selection window in a time domain, and determining an available resource set from the candidate resource set, in response to determining that the first UE is incapable of sharing the COT, and selecting the resource from the available resource set as a transmission resource of the first UE.

### CROSS-REFERENCE

The present application is a U.S. National Stage of International Application No. PCT/CN2022/109812, filed on Aug. 2, 2022, the contents of all of which are incorporated herein by reference in their entireties for all purposes.

### BACKGROUND OF THE INVENTION

In a current sidelink (SL), when determining a transmission resource, a user equipment (UE) first determines a candidate resource set by performing resource exclusion. However, in a sidelink-unlicense (SL-U), a channel occupancy time (COT) sharing mechanism is introduced, and a time-frequency resource can be allocated to the UE within the COT based on a COT sharing mechanism.

### SUMMARY OF THE INVENTION

The present disclosure relates to the technical field of mobile communication, and in particular, to a method and device for selecting a resource.

A method for selecting the resource is provided in an embodiment of a first aspect of the present disclosure, which is performed by a first user equipment (UE). The method includes: receiving channel occupancy time (COT) sharing information from a second UE; determining, based on at least one of the COT sharing information or a preset threshold, whether the first UE is capable of sharing a COT indicated in the COT sharing information; determining, through resource-aware, a candidate resource set within a resource selection window in a time domain; determining an available resource set from the candidate resource set, in response to determining that the first UE is incapable of sharing the COT based on the COT sharing information, where the available resource set includes a resource from the candidate resource set that is not within the COT in the time domain; and selecting the resource from the available resource set as a transmission resource of the first UE.

A method for selecting a resource is provided in an embodiment of a second aspect of the present disclosure. The method is performed by a first user equipment (UE), includes: determining, through resource-aware, a candidate resource set within a resource selection window in a time domain; selecting a first resource from the candidate resource set; receiving channel occupancy time (COT) sharing information from a second UE; determining, based on the COT sharing information, whether the first resource at least partially overlaps with a second resource that is within a COT indicated in the COT sharing information, and the second UE allocates the second resource to a third UE through the COT sharing information; and selecting a transmission resource of the first UE based on a priority of to-be-transmitted data of the first UE and a priority of to-be-transmitted data of the third UE, in response to determining the first resource at least partially overlaps with the second resource.

A communication device is provided in an embodiment of a third aspect of the present disclosure, including: one or more processors and a memory, where the memory stores a computer program, and the computer program stored in the memory, when collectively executed by the one or more processors, causes the communication device to configure to: receive channel occupancy time (COT) sharing information from a second UE; determine, based on at least one of the COT sharing information or a preset threshold, whether the first UE is capable of sharing a COT indicated in the COT sharing information; determine, through resource-aware, a candidate resource set within a resource selection window in a time domain; determine an available resource set from the candidate resource set, in response to determining that the first UE is incapable of sharing the COT based on the COT sharing information, wherein the available resource set comprises a resource from the candidate resource set that is not within the COT in the time domain; and select the resource from the available resource set as a transmission resource of the first UE.

A communication system is provided in an embodiment of a fourth aspect of the present disclosure, including the first user equipment (UE) and a second UE, where the first UE is configured to perform the above method for selecting the resource in the embodiment of the first aspect.

A communication system is provided in an embodiment of a fifth aspect of the present disclosure, including the first user equipment (UE), the second UE, and the third UE, where the first UE is configured to perform the above method for selecting the resource in the embodiment of the second aspect.

A non-transitory computer storage medium is provided in an embodiment of a sixth aspect of the present disclosure, where the computer storage medium storing computer-executable instructions, where the computer-executable instructions, when executed by a processor, implement the above method for selecting the resource in the embodiment of the first aspect.

A communication device is provided in an embodiment of a seventh aspect of the present disclosure, including: one or more processors and a memory, where the memory stores a computer program, and the computer program stored in the memory, when collectively executed by the one or more processors, causes the communication device to perform the above method for selecting the resource in the embodiment of the second aspect.

Additional aspects and advantages of the present disclosure will be given in part in the following description and in part will become apparent from the following description, or learned through practice of the present disclosure.

### BRIEF DESCRIPTION OF DRAWINGS

The above and/or additional aspects and advantages of the present disclosure will become apparent and easily understood from the following description of the embodiments in conjunction with the accompanying drawings, in which:

FIG. 1 is a schematic diagram of an architecture of a communication system according to an embodiment of the present disclosure;

FIG. 2 is a flow diagram of a method for selecting a resource according to an embodiment of the present disclosure;

FIG. 3 is a flow diagram of a method for selecting the resource according to an embodiment of the present disclosure;

FIG. 4 is a flow diagram of a method for selecting the resource according to an embodiment of the present disclosure;

FIG. 5 is a schematic diagram of a method for selecting the resource according to an embodiment of the present disclosure;

FIG. 6 is a flow diagram of a method for selecting the resource according to an embodiment of the present disclosure;

FIG. 7 is a flow diagram of a method for selecting the resource according to an embodiment of the present disclosure;

FIG. 8 is a flow diagram of a method for selecting the resource according to an embodiment of the present disclosure;

FIG. 9 is a schematic diagram of a method for selecting the resource according to an embodiment of the present disclosure;

FIG. 10 is a block diagram of a device for selecting the resource according to an embodiment of the present disclosure;

FIG. 11 is a block diagram of a device for selecting the resource according to an embodiment of the present disclosure;

FIG. 12 is a schematic structural diagram of a communication device provided in an embodiment of the present disclosure; and

FIG. 13 is a schematic structural diagram of a chip provided in an embodiment of the present disclosure.

### DETAILED DESCRIPTION OF THE INVENTION

Embodiments of the present disclosure will be described in detail below, examples of which are shown in the accompanying drawings, where throughout the same or similar reference numerals denote the same or similar elements or elements having the same or similar functions. The following embodiments described with reference to the accompanying drawings are examples and serve to explain the present disclosure, and should not be construed as limiting the present disclosure.

In order to better understand the method and device for selecting the resource disclosed in the embodiments of the present disclosure, a communication system to which the embodiments of the present disclosure are applicable is first described below.

Referring to FIG. 1, in a scenario where sidelink communication is performed between sidelink communication devices, a network device 101 configures various transmission parameters for data transmission for a sidelink communication device 1. The sidelink communication device 1 is determined as a data transmitting end, and a sidelink communication device 2 is determined as a data receiving end. The sidelink communication device 1 and the sidelink communication device 2 perform sidelink communication. The links for communication between the network device and the sidelink communication devices are uplink and downlink, and a link between the sidelink communication devices is a sidelink.

It can be understood that the communication system 10 shown in FIG. 1 is merely for schematic illustration. The communication system 10 may further include other network devices, such as a core network device, a wireless relay device, and a wireless backhaul device, which are not drawn in FIG. 1. The quantity of network devices and terminals included in the communication system 10 is not limited to the embodiments of the present disclosure.

It can be further understood that the wireless communication system in an embodiment of the present disclosure is a network that provides a wireless communication function. The wireless communication system may adopt different communication technologies, such as code division multiple access (CDMA), wideband code division multiple access (WCDMA), time division multiple access (TDMA), frequency division multiple access (FDMA), orthogonal frequency-division multiple access (OFDMA), single carrier FDMA (SC-FDMA), and carrier sense multiple access with collision avoidance. Based on the capacity, rate, latency and other factors of different networks, the networks may be categorized as 2G (generation) networks, 3G networks, 4G networks, or future evolution networks, such as 5G networks, which may also be referred to as new radio (NR) networks. For the convenience of description, the present disclosure sometimes simply refers to the wireless communication network as a network.

Further, the network device involved in the present disclosure may also be referred to as a wireless access network device, which may be: a base station, an evolved node B (eNB), a home base station, an access point (AP) in a wireless fidelity (WIFI) system, a wireless relay node, a wireless backhaul node, a transmission point (TP), or a transmission and reception point (TRP), etc., or may be a gNB in an NR system, or may be a component or part of a device that constitutes a base station, etc. In a case where the communication system is a vehicle-to-everything (V2X) communication system, the network device may also be a vehicle-mounted device. It is to be understood that the specific technology and the specific device form adopted by the network device are not limited to the embodiments of the present disclosure.

Further, the terminal involved in the present disclosure may also be referred to as a terminal device, a user equipment (UE), a mobile station (MS), a mobile terminal (MT), etc., which is a device that provides voice and/or data connectivity for users. For example, the terminal may be a handheld device with a wireless connection function, a vehicle-mounted device, etc. Some examples of terminals at present are: a mobile phone, a pocket personal computer (PPC), a handheld computer, a personal digital assistant (PDA), a laptop, a tablet, a wearable device, or a vehicle-mounted device, etc. In addition, in a case where the communication system is a vehicle-to-everything (V2X) communication system, the terminal device may also be a vehicle-mounted device. It is to be understood that the specific technology and the specific device form adopted by the terminal are not limited to the embodiments of the present disclosure.

In the present disclosure, the communication scenario of sidelink communication between sidelink communication devices may also be a device to device (D2D) communication scenario. The sidelink communication devices for sidelink communication in the embodiments of the present disclosure may include various handheld devices with a wireless communication function, vehicle-mounted devices, the wearable device, a computing device or another processing device connected to a wireless modem, as well as various forms of the user equipment (UE), the mobile station (MS), the terminal, the terminal device, etc. For the convenience of description, the embodiments of the present disclosure are described below using the terminal as an example of the sidelink communication device.

It can be understood that the communication system described in an embodiment of the present disclosure is intended to more clearly illustrate the technical solution in the embodiments of the present disclosure, and does not constitute a limitation on the technical solution provided in the embodiments of the present disclosure. Those of ordinary skill in the art may learn that with the evolution of the system architecture and the emergence of new business scenarios, the technical solution provided in the embodiments of the present disclosure is also applicable to similar technical problems.

In a current sidelink (SL), in a case where the user equipment (UE) determines a transmission resource, the UE first determines a candidate resource set by performing resource exclusion. However, in a sidelink-unlicense (SL-U), a channel occupancy time (COT) sharing mechanism is introduced, and a time-frequency resource can be allocated to the UE within a COT based on the COT sharing mechanism. Under the COT sharing mechanism, how the UE determines the transmission resource has become an urgent problem to be solved.

In view of this, the present disclosure provides a method and device for selecting a resource, so that the UE may select the transmission resource under the COT sharing mechanism, ensuring reliable data transmission by the UE using the transmission resource, while effectively preventing the failure of the COT sharing mechanism between a COT-initiating UE and another UE.

The method and device for selecting the resource provided in the present disclosure are described in detail below in conjunction with the accompanying drawings.

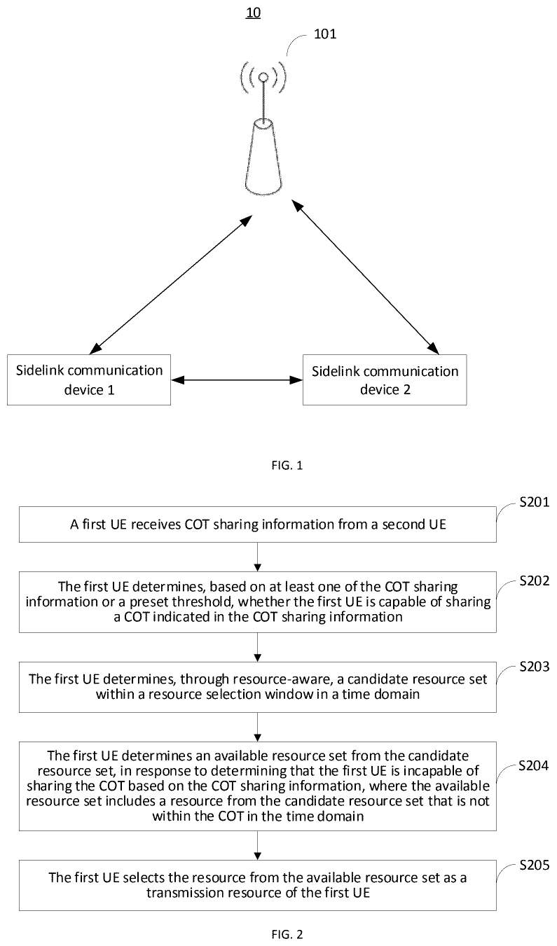

FIG. 2 shows a flow diagram of a method for selecting the resource according to an embodiment of the present disclosure. As shown in FIG. 2, the method may include the following steps.

S201, a first UE receives COT sharing information from a second UE.

In the embodiment, the second UE refers to a COT-initiating UE. Under the COT sharing mechanism, the COT-initiating UE may send COT sharing information to another UE. The COT sharing information may carry related information of a COT shared by the COT-initiating UE and another UE.

The COT-initiating UE may use cat 1 lbt (Category 1 Listen Before Talk) to initiate one COT, and send the COT sharing information.

S202, the first UE determines, based on at least one of the COT sharing information or a preset threshold, whether the first UE is capable of sharing a COT indicated in the COT sharing information.

After receiving the COT sharing information, the first UE may determine, based on at least one of the COT sharing information or the preset threshold, whether the first UE is capable of sharing the COT indicated in the COT sharing information.

In some implementations, the COT sharing information sent by the second UE may include an identifier of a UE that the second UE expects to share the resource. For example, in a case where the second UE expects to share the resource with the first UE, the second UE may carry the identifier of the first UE in the COT sharing information sent. In this way, after receiving the COT sharing information, the first UE may determine that the COT indicated in the COT sharing information is shared by the second UE and the first UE, based on the identifier of the first UE carried. In a case where the identifier of the UE carried in the COT sharing information received by the first UE is an identifier of a third UE other than the first UE, the first UE may determine that the COT indicated in the COT sharing information is shared by the second UE and the third UE.

In some implementations, after receiving the COT sharing information, the first UE may determine, based on the preset threshold, whether the first UE is capable of sharing the COT indicated in the COT sharing information.

The preset threshold may include a reference signal receiving power (RSRP) threshold, a distance threshold, etc.

S203, the first UE determines, through resource-aware, a candidate resource set within a resource selection window in a time domain.

The first UE may determine the candidate resource set through resource-aware according to the related technology, for example, according to a resource selection process in Release 16. Specifically, the resource selection window may be determined first, and then the candidate resource set within the resource selection window in the time domain may be determined, which will not be repeated here.

S204, the first UE determines an available resource set from the candidate resource set, in response to determining that the first UE is incapable of sharing the COT based on the COT sharing information, where the available resource set includes a resource from the candidate resource set that is not within the COT in the time domain.

In a case where the first UE determines that the COT is incapable of being shared, i.e., the resource within the COT is incapable of being used, the first UE may obtain the available resource set by excluding from the candidate resource set the resource within the COT in the time domain.

S205, the first UE selects the resource from the available resource set as a transmission resource of the first UE.

The first UE may select, after determining the available resource set, the resource from the available resource set as the transmission resource for transmitting data.

According to the method for selecting the resource in the embodiment of the present disclosure, the first UE receives COT sharing information from the second UE; determines, based on the COT sharing information, whether the first UE is capable of sharing the COT indicated in the COT sharing information; determines, through resource-aware, the candidate resource set within the resource selection window in the time domain; in response to determining that the first UE is incapable of sharing the COT, determines the available resource set from the candidate resource set; and selects the resource from the available resource set as the transmission resource of the first UE. Thus, according to the method for selecting the resource in the embodiment, in a case where the first UE is incapable of sharing the COT, the transmission resource selected by the first UE is not allocated by the second UE to another UE through the COT sharing mechanism, thereby effectively preventing the failure of the COT sharing mechanism between the second UE and another UE, while ensuring reliable data transmission by the first UE using the transmission resource.

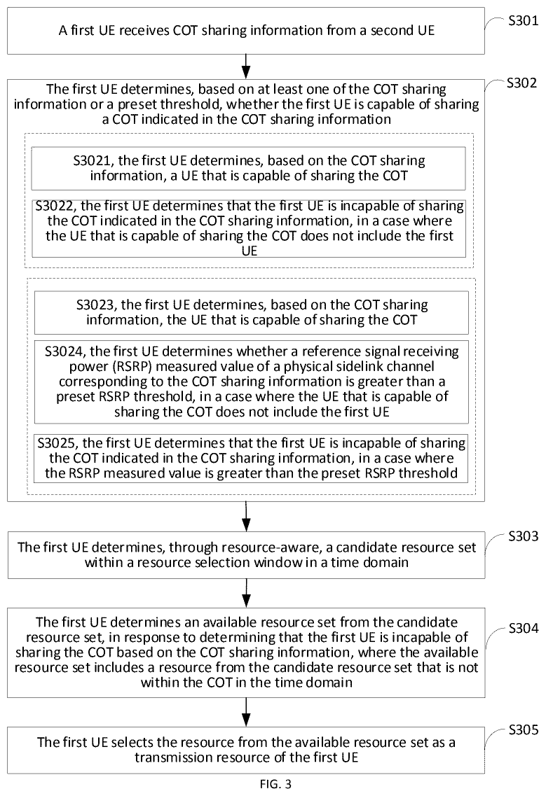

FIG. 3 shows a flow diagram of a method for selecting the resource according to an embodiment of the present disclosure. As shown in FIG. 3, the method may include the following steps.

S301, a first UE receives COT sharing information from a second UE.

S302, the first UE determines, based on at least one of the COT sharing information or a preset threshold, whether the first UE is capable of sharing a COT indicated in the COT sharing information.

For the description and specific details of the above steps S301-S302, reference may be made to the related description and details of the above steps S201-S202.

In some embodiments, the above step S302 may include the following steps.

S3021, the first UE determines, based on the COT sharing information, a UE that is capable of sharing the COT.

S3022, the first UE determines that the first UE is incapable of sharing the COT indicated in the COT sharing information, in a case where the UE that is capable of sharing the COT does not include the first UE.

In an implementation, the COT sharing information sent by a COT-initiating UE may carry an identifier of a UE that the COT-initiating UE expects to share the resource. For example, in a case where the second UE that is the COT-initiating UE expects to share the resource with the first UE, the second UE may carry the identifier of the first UE in the COT sharing information sent. In this way, after receiving the COT sharing information, the first UE may determine, based on the identifier of the first UE carried, that the resource indicated in the COT sharing information is shared by the second UE and the first UE.

In a case where an identifier of the UE carried in the COT sharing information received by the first UE is an identifier of another UE other than the first UE, the first UE may determine that the resource within the COT indicated in the COT sharing information is shared by the second UE and another UE. Thus, the first UE may determine that it is incapable of using the resource within the COT indicated in the COT sharing information because the resource within the COT is allocated to another UE instead of the first UE.

In other embodiments, the above step S302 may include the following steps.

S3023, the first UE determines, based on the COT sharing information, the UE that is capable of sharing the COT.

S3024, the first UE determines whether a reference signal receiving power (RSRP) measured value of a physical sidelink channel corresponding to the COT sharing information is greater than a preset RSRP threshold, in a case where the UE that is capable of sharing the COT does not include the first UE.

S3025, the first UE determines that the first UE is incapable of sharing the COT indicated in the COT sharing information, in a case where the RSRP measured value is greater than the preset RSRP threshold.

In some cases, in a case where the first UE determines, based on the received COT sharing information, that the resource within the COT indicated in the COT sharing information is shared by the second UE that is the COT initiating UE and a third UE other than the first UE, if the first UE is far away from the second UE, the first UE, even if using the resource within the COT indicated in the COT sharing information, does not cause interference to the second UE and the third UE using the resource within the COT. That is, if the first UE is far away from the second UE, even if the COT sharing information received by the first UE from the second UE indicates that the resource within the COT indicated in the COT sharing information is shared by the second UE and the third UE other than the first UE, the first UE can still use the resource within the COT. In this case, when the first UE determines whether it is capable of sharing the COT indicated in the COT sharing information, the first UE also needs to determine whether the first UE is not far enough away from the second UE in addition to determining whether the COT indicated in the COT sharing information is shared by the second UE and the third UE other than the first UE, for example, determine whether a distance between the first UE and the second UE is within a certain distance threshold.

In an implementation, the first UE may determine whether the first UE is not far enough away from the second UE by determining whether an RSRP measured value of a physical sidelink channel corresponding to the COT sharing information is greater than an RSPR threshold. For example, in a case where the first UE determines, based on the received COT sharing information, that the COT indicated in the COT sharing information is shared by the second UE and a third UE other than the first UE and that the RSRP measured value of the physical sidelink channel corresponding to the COT sharing information is greater than the RSRP threshold, it indicates that the distance between the first UE and the second UE is relatively close. If the first UE uses the resource within the COT indicated in the COT sharing information, which would cause interference to the second UE or the third UE using the resource within the COT. Therefore, the first UE will determine that the resource within the COT cannot be used.

The physical sidelink channel may be either a physical sidelink control channel (PSCCH) or a physical sidelink shared channel (PSSCH).

In another implementation, the first UE may determine, according to a distance threshold, whether the first UE is capable of sharing the COT indicated in the COT sharing information. Specifically, the first UE may determine whether the distance between the first UE and the second UE is greater than the distance threshold. In a case where the distance is greater than the distance threshold, the first UE determines that it is capable of sharing the COT indicated in the COT sharing information. In a case where the distance is not greater than the distance threshold, the first UE determines that it is incapable of sharing the COT indicated in the COT sharing information.

The RSRP threshold or the distance threshold may be a pre-defined or pre-configured fixed value or may be one of a plurality of pre-configured values indicated in sidelink control information (SCI) or downlink control information (DCI).

S303, the first UE determines, through resource-aware, a candidate resource set within a resource selection window in a time domain.

S304, the first UE determines an available resource set from the candidate resource set, in response to determining that the first UE is incapable of sharing the COT based on the COT sharing information, where the available resource set includes a resource from the candidate resource set that is not within the COT in the time domain.

S305, the first UE selects the resource from the available resource set as a transmission resource of the first UE.

For the description and specific details of the above steps S303-S305, reference may be made to the related description and details of the above steps S203-S205.

According to the method for selecting the resource in the embodiment of the present disclosure, the first UE receives COT sharing information from the second UE; determines, based on the COT sharing information, whether the first UE is capable of sharing the COT indicated in the COT sharing information; determines, through resource-aware, the candidate resource set within the resource selection window in the time domain; determines the available resource set from the candidate resource set, in response to determining that the first UE is incapable of sharing the COT; and selects the resource from the available resource set as the transmission resource of the first UE. Thus, according to the method for selecting the resource in the embodiment, in a case where the first UE is incapable of sharing the COT, the transmission resource selected by the first UE is not allocated by the second UE to another UE through the COT sharing mechanism, thereby effectively preventing the failure of the COT sharing mechanism between the second UE and another UE, while ensuring reliable data transmission by the first UE using the transmission resource.

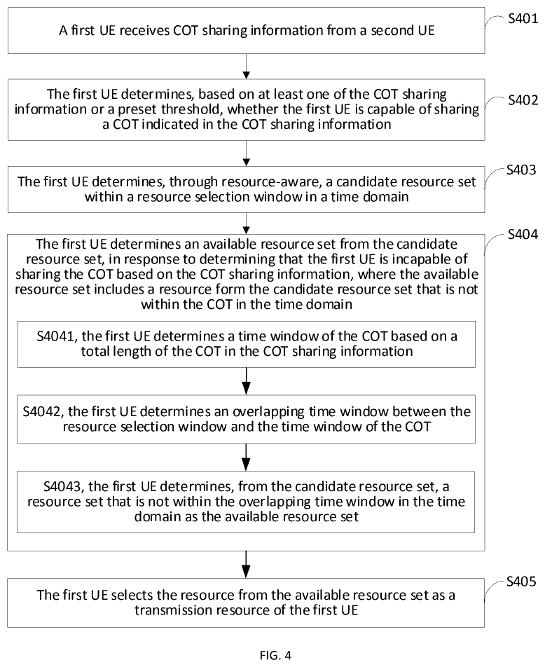

FIG. 4 shows a flow diagram of a method for selecting the resource according to an embodiment of the present disclosure. As shown in FIG. 4, the method may include the following steps.

S401, a first UE receives COT sharing information from a second UE.

S402, the first UE determines, based on at least one of the COT sharing information or a preset threshold, whether the first UE is capable of sharing a COT indicated in the COT sharing information.

S403, the first UE determines, through resource-aware, a candidate resource set within a resource selection window in a time domain.

S404, the first UE determines an available resource set from the candidate resource set, in response to determining that the first UE is incapable of sharing the COT based on the COT sharing information, where the available resource set includes a resource from the candidate resource set that is not within the COT in the time domain.

For the description and specific details of the above steps S401-S404, reference may be made to the related description and details of the above steps S301-S304.

In some embodiments, the above step S404 may include the following steps.

S4041, the first UE determines a time window of the COT based on a total length of the COT in the COT sharing information.

The COT sharing information may indicate the total length of the COT.

The first UE may decode, after receiving the COT sharing information, to obtain a time slot in which a COT-initiating UE sends the COT sharing information, that is, a start time slot of a COT initiated by the COT-initiating UE. For example, a first UE UE1 may determine that the start time slot of the COT initiated by the COT-initiating UE is t1 as shown in FIG. 5. In addition, the COT sharing information indicates that the total length of the COT is L, in which case, the first UE may determine that an end position of the COT initiated by the COT-initiating UE is t1+L, that is, t2 shown in FIG. 5. Thus, the first UE may determine that the time window of the COT initiated by the COT-initiating UE is [t1, t2].

S4042, the first UE determines an overlapping time window between the resource selection window and the time window of the COT.

The first UE may determine, after determining the time window of the COT, the overlapping time window between the resource selection window and the time window of the COT.

A later time between a start time of the resource selection window and a start time of the time window of the COT may be determined as a start time of the overlapping time window, and an earlier time between an end time of the time window of the COT and an end time of the resource selection window may be determine as an end time of the overlapping time window.

For example, as shown in FIG. 5, the resource selection window is [n+T1, n+T2], and the time window of the COT is [t1, t2], in which case, the overlapping time window between the resource selection window and the time window of the COT is [t3, t4], where t3=max {t3, n+T1}. The COT initiated by the COT-initiating UE is prior to the first UE executing resource selection, that is, t3<n+T1, and therefore t3=n+T1, and t4-min {n+T2, t2}.

S4043, the first UE determines, from the candidate resource set, a resource set that is not within the overlapping time window in the time domain as the available resource set.

After determining the overlapping time window, the first UE may obtain the available resource set by excluding from the candidate resource set resource within the overlapping time window in the time domain.

For example, the resource in the candidate resource set that is within [t3, t4] in the time domain is excluded as shown in FIG. 5.

S405, the first UE selects the resource from the available resource set as a transmission resource of the first UE.

For the description and specific details of the above step S405, reference may be made to the related description and details of the above step S305.

According to the method for selecting the resource in the embodiment of the present disclosure, the first UE receives COT sharing information from the second UE; determines, based on the COT sharing information, whether the first UE is capable of sharing the COT indicated in the COT sharing information; determines, through resource-aware, the candidate resource set within the resource selection window in the time domain; determines the available resource set from the candidate resource set, in response to determining that the first UE is incapable of sharing the COT; and selects the resource from the available resource set as the transmission resource of the first UE. Thus, according to the method for selecting the resource in the embodiment, in a case where the first UE is incapable of sharing the COT, the transmission resource selected by the first UE is not allocated by the second UE to another UE through the COT sharing mechanism, thereby effectively preventing the failure of the COT sharing mechanism between the second UE and another UE, while ensuring reliable data transmission by the first UE using the transmission resource.

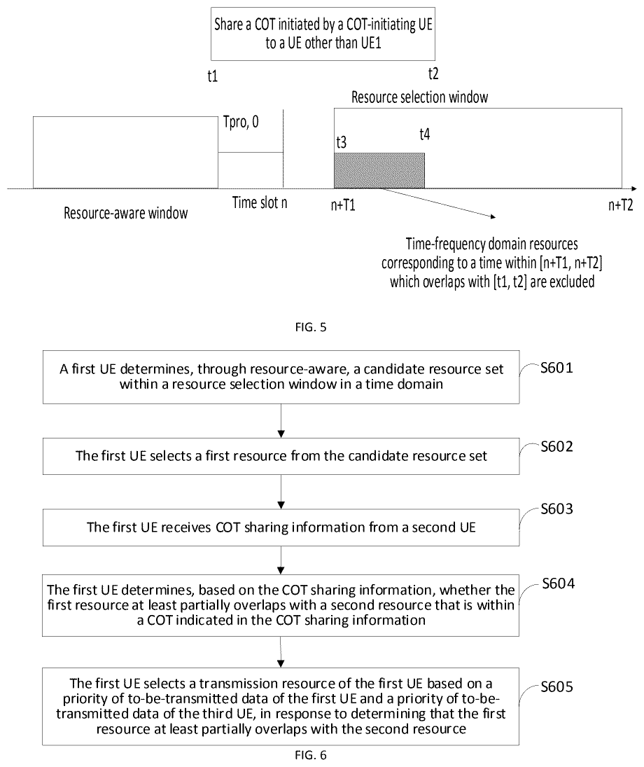

FIG. 6 shows a flow diagram of a method for selecting the resource according to an embodiment of the present disclosure. As shown in FIG. 6, the method may include the following steps.

S601, a first UE determines, through resource-aware, a candidate resource set within a resource selection window in a time domain.

The first UE may determine the candidate resource set through resource-aware according to the related technology, for example, according to a resource selection process in Release 16. Specifically, the resource selection window may be determined first, and then the candidate resource set within the resource selection window in the time domain may be determined, which will not be repeated here.

S602, the first UE selects a first resource from the candidate resource set.

The first UE may select, after determining the candidate resource set, any resource from the candidate resource set as the first resource.

S603, the first UE receives COT sharing information from a second UE.

In the embodiment, the second UE refers to a COT-initiating UE. Under a COT sharing mechanism, the COT-initiating UE may send COT sharing information to another UE. The COT sharing information may carry related information of a COT shared by the COT-initiating UE and another UE.

The COT-initiating UE may use CAT1 LBT to initiate one COT, and send the COT sharing information.

S604, the first UE determines, based on the COT sharing information, whether the first resource at least partially overlaps with a second resource that is within a COT indicated in the COT sharing information, where the second UE allocates the second resource to a third UE through the COT sharing information.

S605, the first UE selects a transmission resource of the first UE based on a priority of to-be-transmitted data of the first UE and a priority of to-be-transmitted data of the third UE, in response to determining that the first resource at least partially overlaps with the second resource.

After receiving the COT sharing information sent by the COT-initiating UE, the first UE may determine, based on the COT sharing information, whether the first resource selected by the first UE at least partially overlaps with the second resource allocated to the third UE other than the first UE. If the first UE determines that the first resource selected by the first UE is at least partially overlapped by the second resource allocated to the third UE, the first UE determines the transmission resource of the first UE based on the priority of to-be-transmitted data of the first UE and the priority of to-be-transmitted data of the third UE.

In an implementation, the COT sharing information sent by the second UE that is a COT-initiating UE may carry an identifier of a UE that the second UE expects to share the resource. For example, in a case where the second UE expects to share the resource with the first UE, the second UE may carry the identifier of the first UE in the COT sharing information sent. In this way, after receiving the COT sharing information, the first UE may determine, based on the identifier of the first UE carried, that the resource indicated in the COT sharing information is shared by the second UE and the first UE, that is, the second UE allocates part of the resources within the COT to the first UE through the COT sharing information.

In a case where the identifier of the UE carried in the COT sharing information received by the first UE is an identifier of a third UE other than the first UE, the first UE may determine that the resource within the COT indicated in the COT sharing information is shared by the second UE and the third UE, that is, the second UE allocates part of the resources within the COT to the third UE through the COT sharing information. For example, the resource selected by the first UE through resource selection is the first resource, and the first UE determines, based on the COT sharing information, that the second UE allocates the second resource to the third UE. The first resource at least partially overlaps with the second resource, in which case, the first UE may determine the transmission resource of the first UE based on the priority of the to-be-transmitted data of the first UE and the priority of the to-be-transmitted data of the third UE.

In other embodiments, in response to determining, based on the COT sharing information, that the first resource selected by the first UE does not overlap with any resource allocated to the third UE other than the first UE, the first UE may determine the selected first resource as the transmission resource.

According to the method for selecting the resource in the embodiment of the present disclosure, the first UE receives COT sharing information from the second UE; determines, through resource-aware, the candidate resource set within the resource selection window in the time domain; selects the first resource from the candidate resource set; determines, based on the COT sharing information, whether the first resource at least partially overlaps with the second resource that is within the COT indicated in the COT sharing information and allocated by the second UE to the third UE; and selects the transmission resource of the first UE based on the priority of the to-be-transmitted data of the first UE and the priority of the to-be-transmitted data of the third UE, in response to determining that the first resource at least partially overlaps with the second resource. Thus, according to the method for selecting the resource in the embodiment, in a case where the first UE failing to obtain the COT sharing information before selecting the resource, which results in the transmission resource selected by the first UE at least partially overlapping with the resource allocated by the second UE to the third UE through the COT sharing mechanism, a resource conflict between the first UE and the third UE can be avoided, thereby effectively preventing the failure of the COT sharing mechanism between the second UE and the third UE, while ensuring reliable data transmission by the first UE using the transmission resource.

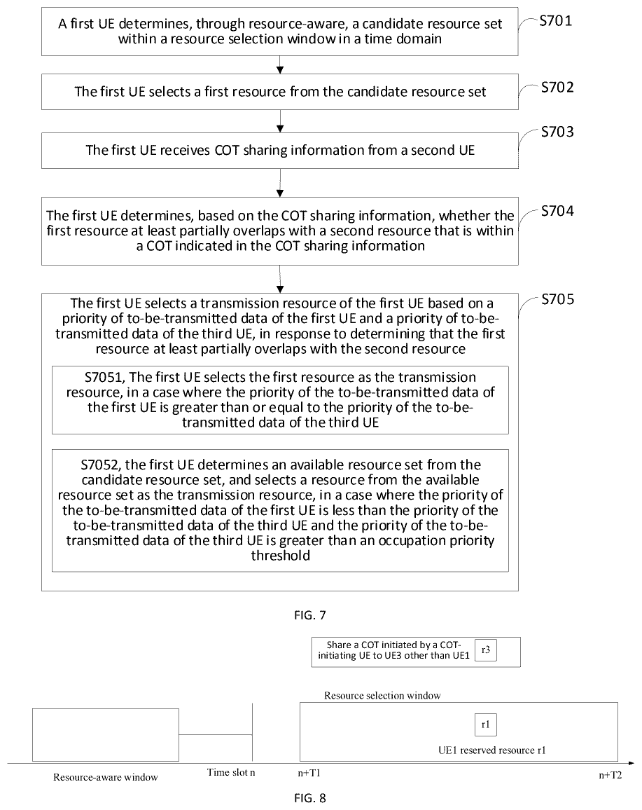

FIG. 7 shows a flow diagram of a method for selecting the resource according to an embodiment of the present disclosure. As shown in FIG. 7, the method may include the following steps.

S701, a first UE determines, through resource-aware, a candidate resource set within a resource selection window in a time domain.

S702, the first UE selects a first resource from the candidate resource set.

S703, the first UE receives COT sharing information from a second UE.

S704, the first UE determines, based on the COT sharing information, whether the first resource at least partially overlaps with a second resource that is within a COT indicated in the COT sharing information, where the second UE allocates the second resource to a third UE through the COT sharing information.

S705, the first UE selects a transmission resource of the first UE based on a priority of to-be-transmitted data of the first UE and a priority of to-be-transmitted data of the third UE, in response to determining that the first resource at least partially overlaps with the second resource.

For the description and specific details of the above steps S701-S705, reference may be made to the related description and details of the above steps S601-S605.

In some embodiments, the above step S705 may include any of the following steps.

S7051, the first UE selects the first resource as the transmission resource, in a case where the priority of the to-be-transmitted data of the first UE is greater than or equal to the priority of the to-be-transmitted data of the third UE,.

In a case where the first resource and the second resource at least overlap, if the priority of the first UE for transmitting data using the first resource is greater than or equal to the priority of the third UE for transmitting data using the second resource, the third UE is incapable of transmitting data using the second resource. Therefore, the first UE selects the first resource as the transmission resource.

S7052, the first UE determines an available resource set from the candidate resource set, and selects a resource from the available resource set as the transmission resource, in a case where the priority of the to-be-transmitted data of the first UE is less than the priority of the to-be-transmitted data of the third UE and the priority of the to-be-transmitted data of the third UE is greater than an occupation priority threshold.

In a case where the first resource and the second resource at least overlap, if the priority of the first UE for transmitting data using the first resource is less than the priority of the third UE for transmitting data using the second resource and the priority of the third UE for transmitting data using the second resource is greater than the occupation priority threshold, it indicates that the second UE may occupy the second resource. Therefore, the first UE is incapable of selecting the first resource as the transmission resource and needs to perform resource reselection.

The first UE, when performing resource reselection, may obtain the available resource set by excluding from the candidate resource set resource within the COT in the time domain, and select the resource from the available resource set as the transmission resource, where the candidate resource set is determined by the first UE through resource-aware before resource selection is triggered. For example, the candidate resource set may be determined by the first UE according to a resource selection process in Release 16. The specific process may refer to the related description of Release 16 and will not be repeated here.

For example, the resource selected by the first UE UE1 through resource selection is r1 as shown in FIG. 8. The first UE determines, after receiving the COT sharing information, that the resource r1 is within the COT, and the resource within a COT initiated by a COT-initiating UE is shared to a third UE UE3 other than the first UE. Moreover, the COT-initiating UE allocates a resource to UE3 which is about to share the resource r3 within the COT, and the resource r1 and the resource r3 experience a resource overlap (partial overlap or full overlap). Thus, UE1 needs to determine a transmission resource of UE1 based on a priority of to-be-transmitted data of UEL and a priority of to-be-transmitted data of UE3.

If the priority of the to-be-transmitted data of UE1 is greater than or equal to the priority of the to-be-transmitted data of UE3, UE1 will use r1 and UE3 will be incapable of using r3 allocated by the COT.

If the priority of the to-be-transmitted data of UEL is less than the priority of the to-be-transmitted data of UE3 and the priority of the to-be-transmitted data of UE3 is greater than the occupation priority threshold, UE3 will occupy the resource r1 of UEL, and UE1 needs to reselect a resource from the candidate resource set, to determine the transmission resource. When performing resource reselection, UE1 may obtain the available resource set by excluding from the candidate resource set resource within the COT initiated by the COT-initiating UE in the time domain, and select the transmission resource from the available resource set, thereby preventing the reselected resource from overlapping with the resource allocated to UE3.

According to the method for selecting the resource in the embodiment of the present disclosure, the first UE receives COT sharing information from the second UE; determines, through resource-aware, the candidate resource set within the resource selection window in the time domain; selects the first resource from the candidate resource set; determines, based on the COT sharing information, whether the first resource at least partially overlaps with the second resource that is within the COT indicated in the COT sharing information and allocated by the second UE to the third UE; and selects the transmission resource of the first UE based on the priority of the to-be-transmitted data of the first UE and the priority of the to-be-transmitted data of the third UE, in response to determining that the first resource at least partially overlaps with the second resource. Thus, according to the method for selecting the resource in the embodiment, in a case where the first UE failing to obtain the COT sharing information before selecting the resource, which results in the transmission resource selected by the first UE at least partially overlapping with the resource allocated by the second UE to the third UE through the COT sharing mechanism, a resource conflict between the first UE and the third UE can be prevented, thereby effectively preventing the failure of the COT sharing mechanism between the second UE and the third UE, while ensuring reliable data transmission by the first UE using the transmission resource.

FIG. 9 shows a flow diagram of a method for selecting the resource according to an embodiment of the present disclosure. As shown in FIG. 9, the method may include the following steps.

S901, a first UE determines, through resource-aware, a candidate resource set within a resource selection window in a time domain.

S902, the first UE selects a first resource from the candidate resource set.

S903, the first UE receives COT sharing information from a second UE.

S904, the first UE determines, based on the COT sharing information, whether the first resource at least partially overlaps with a second resource that is within a COT indicated in the COT sharing information, where the second UE allocates the second resource to a third UE through the COT sharing information.

S905, the first UE determines an available resource set from the candidate resource set, in response to determining that the first resource at least partially overlaps with the second resource, and a priority of to-be-transmitted data of the first UE is less than a priority of to-be-transmitted data of the third UE and a priority of the to-be-transmitted data of the third UE is greater than an occupation priority threshold, where the available resource set includes a resource from the candidate resource set that is not within the COT in the time domain.

For the description and specific details of the above steps S901-S905, reference may be made to the related description and details of the above steps S701-S705.

In some embodiments, the above step S905 may include any of the following steps.

S9051, the first UE determines a time window of the COT based on a total length of the COT in the COT sharing information.

The COT sharing information may indicate the total length of the COT.

The first UE may decode, after receiving the COT sharing information, to obtain a time slot in which a COT-initiating UE sends the COT sharing information, that is, a start time slot of the COT initiated by the COT-initiating UE. For example, the first UE UE1 may determine that the start time slot of the COT initiated by the COT-initiating UE is t1 as shown in FIG. 5. In addition, the COT sharing information indicates that the total length of the COT is L, in which case, the first UE may determine that an end position of the COT initiated by the COT-initiating UE is t1+L, that is, t2 shown in FIG. 5. Thus, the first UE may determine that the time window of the COT initiated by the COT-initiating UE is [t1, t2].

S9052, the first UE determines an overlapping time window between the resource selection window and the time window of the COT.

The first UE may determine, after determining the time window of the COT, an overlapping time window between the resource selection window and the time window of the COT.

A later time between a start time of the resource selection window and a start time of the time window of the COT may be determined as a start time of the overlapping time window, and an earlier time between an end time of the time window of the COT and an end time of the resource selection window may be determined as an end time of the overlapping time window.

For example, as shown in FIG. 5, the resource selection window is [n+T1, n+T2], and the time window of the COT is [t1, t2], in which case, the overlapping time window between the resource selection window and the time window of the COT is [t3, t4], where t3=max {t3, n+T1}. The COT initiated by the COT-initiating UE is prior to the first UE executing resource selection, that is, t3<n+T1, and therefore t3=n+T1, and t4=min {n+T2, t2}.

S9053, the first UE determines, from the candidate resource set, a resource set that is not within the overlapping time window in the time domain as the available resource set.

After determining the overlapping time window, the first UE may obtain the available resource set by excluding from the candidate resource set resource within the overlapping time window in the time domain.

For example, the resource in the candidate resource set that is within [t3, t4] in the time domain is excluded as shown in FIG. 5.

S906, the first UE selects a resource from the available resource set as a transmission resource.

According to the method for selecting the resource in the embodiment of the present disclosure, the first UE receives COT sharing information from the second UE; determines, through resource-aware, the candidate resource set within the resource selection window in the time domain; selects the first resource from the candidate resource set; determines, based on the COT sharing information, whether the first resource at least partially overlaps with a second resource that is within the COT indicated in the COT sharing information and allocated by the second UE to the third UE; and selects the transmission resource of the first UE based on the priority of the to-be-transmitted data of the first UE and the priority of the to-be-transmitted data of the third UE, in response to determining that the first resource at least partially overlaps with the second resource. Thus, according to the method for selecting the resource in the embodiment, in a case where the first UE failing to obtain the COT sharing information before selecting the resource, which results in the transmission resource selected by the first UE at least partially overlapping with the resource allocated by the second UE to the third UE through the COT sharing mechanism, a resource conflict between the first UE and the third UE can be prevented, thereby effectively preventing the failure of the COT sharing mechanism between the second UE and the third UE, while ensuring reliable data transmission by the first UE using the transmission resource.

In the above embodiments provided in the present disclosure, the method provided in the embodiment of the present disclosure is introduced from the perspective of a user equipment. In order to implement the various functions in the above method provided in the embodiment of the present disclosure, the user equipment may include a hardware structure and a software module, and implement the above various functions in the form of the hardware structure, the software module, or the hardware structure plus the software module. Any of the above various functions may be implemented via the hardware structure, the software module, or the hardware structure plus the software module.

Corresponding to the method for selecting the resource provided in the above several embodiments, the present disclosure also provides a device for selecting the resource. Since the device for selecting the resource provided in the embodiment of the present disclosure corresponds to the method for selecting the resource provided in the above several embodiments, the implementation of the method for selecting the resource is also applicable to the device for selecting the resource provided in this embodiment and will not be described in detail in the embodiment.

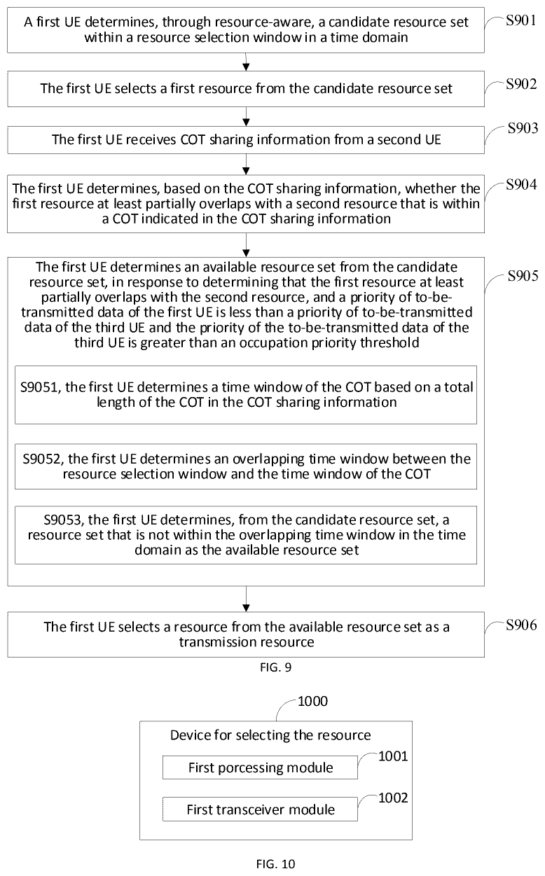

FIG. 10 is a schematic structural diagram of a device 1000 for selecting the resource provided in an embodiment of the present disclosure. The device 1000 for selecting the resource may be a first UE.

As shown in FIG. 10, the device 1000 may include a first processing module 1001 and a first transceiver module 1002.

The first transceiver module 1002 is configured to receive channel occupancy time (COT) sharing information from a second user equipment (UE).

The first processing module 1001 is configured to determine, based on at least one of the COT sharing information or a preset threshold, whether the device for selecting the resource is capable of sharing a COT indicated in the COT sharing information; determine, through resource-aware, a candidate resource set within a resource selection window in a time domain; determine an available resource set from the candidate resource set, in response to determining that the device for selecting the resource is incapable of sharing the COT based on the COT sharing information, where the available resource set includes a resource from the candidate resource set that is not within the COT in the time domain; and select the resource from the available resource set as a transmission resource for the device for selecting the resource.

According to the device for selecting the resource in the embodiment of the present disclosure, the first UE receives COT sharing information from the second UE; determines, based on the COT sharing information, whether the first UE is capable of sharing the COT indicated in the COT sharing information; determines, through resource-aware, the candidate resource set within the resource selection window in the time domain; determines the available resource set from the candidate resource set, in response to determining that the first UE is incapable of sharing the COT; and selects the resource from the available resource set as the transmission resource of the first UE. Thus, according to the device for selecting the resource of the embodiment, in a case where the first UE is incapable of sharing the COT, the transmission resource selected by the first UE is not allocated by the second UE to another UE through a COT sharing mechanism, thereby effectively preventing the failure of the COT sharing mechanism between the second UE and another UE, while ensuring reliable data transmission by the first UE using the transmission resource.

In some embodiments, the first processing module 1001 is further configured to: determine, based on the COT sharing information, a UE that is capable of sharing the COT; and determine the device for selecting the resource is incapable of sharing the COT indicated in the COT sharing information, in a case where the UE that is capable of sharing the COT does not include the device for selecting the resource.

In some embodiments, the first processing module 1001 is further configured to: determine, based on the COT sharing information, a UE that is capable of sharing the COT; determine whether a reference signal receiving power (RSRP) measured value of a physical sidelink channel corresponding to the COT sharing information is greater than a preset RSRP threshold, in a case where the UE that is capable of sharing the COT does not include the device for selecting the resource; and determine the device for selecting the resource is incapable of sharing the COT indicated in the COT sharing information, in a case where the RSRP measured value is greater than the preset RSRP threshold.

In some embodiments, the first processing module 1001 is further configured to: determine a time window of the COT based on a total length of the COT in the COT sharing information; determine an overlapping time window between the resource selection window and the time window of the COT; and determine, from the candidate resource set, a resource set that is not within the overlapping time window in the time domain as the available resource set.

In some embodiments, the first processing module 1001 is further configured to: determine a later time between a start time of the resource selection window and a start time of the time window of the COT as a start time of the overlapping time window, and determine an earlier time between an end time of the time window of the COT and an end time of the resource selection window as an end time of the overlapping time window.

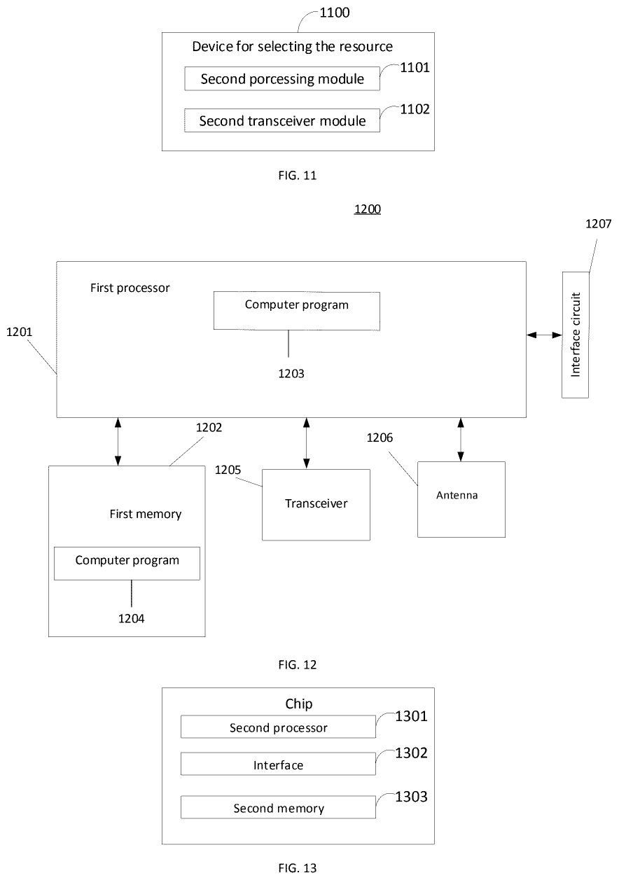

FIG. 11 is a schematic structural diagram of a device 1100 for selecting the resource provided in an embodiment of the present disclosure. The device 1100 for selecting the resource may be a first UE.

As shown in FIG. 11, the device 1100 may include a second processing module 1101 and a second transceiver module 1102.

The second transceiver module 1102 is configured to receive channel occupancy time (COT) sharing information from a second user equipment (UE).

The second processing module 1101 is configured to determine, through resource-aware, a candidate resource set within a resource selection window in a time domain; select a first resource from the candidate resource set; determine, based on COT sharing information, whether the first resource at least partially overlaps with a second resource that is within a COT indicated in the COT sharing information, where the second UE allocates the second resource to a third UE through the COT sharing information; and select a transmission resource of the first UE based on a priority of to-be-transmitted data of the first UE and a priority of to-be-transmitted data of the third UE, in response to determining that the first resource at least partially overlaps with the second resource.

According to the device 1100 for selecting the resource in the embodiment, the first UE receives COT sharing information from the second UE; determines, through resource-aware, the candidate resource set within the resource selection window in the time domain; selects the first resource from the candidate resource set; determines, based on the COT sharing information, whether the first resource at least partially overlaps with the second resource that is within the COT indicated in the COT sharing information and allocated by the second UE to the third UE; and selects the transmission resource of the first UE based on the priority of to-be-transmitted data of the first UE and the priority of to-be-transmitted data of the third UE, in response to determining that the first resource at least partially overlaps with the second resource. Thus, according to the device for selecting the resource of the embodiment, in a case where the first UE failing to obtain the COT sharing information before selecting the resource, which results in the transmission resource selected by the first UE at least partially overlapping with the resource allocated by the second UE to the third UE through the COT sharing mechanism, a resource conflict between the first UE and the third UE can be prevented, thereby effectively preventing the failure of the COT sharing mechanism between the second UE and the third UE, while ensuring reliable data transmission by the first UE using the transmission resource.

In some embodiments, the second processing module 1101 is further configured to: select the first resource as the transmission resource, in a case where the priority of the to-be-transmitted data of the first UE is greater than the priority of the to-be-transmitted data of the third UE.

In some embodiments, the second processing module 1101 is further configured to: determine an available resource set from the candidate resource set, in a case where the priority of the to-be-transmitted data of the first UE is less than the priority of the to-be-transmitted data of the third UE and the priority of the to-be-transmitted data of the third UE is greater than an occupation priority threshold, where the available resource set includes a resource from the candidate resource set that is not within the COT in the time domain; and select the resource from the available resource set as the transmission resource.

In some embodiments, the second processing module 1101 is further configured to: determine a time window of the COT based on a total length of the COT in the COT sharing information; determine an overlapping time window between the resource selection window and the time window of the COT; and determine, from the candidate resource set, a resource set that is not within the overlapping time window in the time domain as the available resource set.

In some embodiments, the second processing module 1101 is further configured to: determine a later time between a start time of the resource selection window and a start time of the time window of the COT as a start time of the overlapping time window, and determine an earlier time between an end time of the time window of the COT and an end time of the resource selection window as an end time of the overlapping time window.

An embodiment of the present disclosure further provides a communication system, including a first UE and a second UE. The second UE is configured to send COT sharing information, so as to allocate, through the COT sharing information, the resource within a COT indicated in the COT sharing information to a third UE. The first UE is configured to perform the method for selecting the resource described above with reference to FIGS. 2 to 5.

An embodiment of the present disclosure further provides a communication system, including a first UE, a second UE, and a third UE. The second UE sends COT sharing information, so as to allocate, through the COT sharing information, the resource within a COT indicated in the COT sharing information to the third UE. The first UE is configured to perform the method for selecting the resource described above with reference to FIGS. 6 to 9.

Referring to FIG. 12, FIG. 12 is a schematic structural diagram of a communication device 1200 provided in an embodiment of the present disclosure. The communication device 1200 may be a network device, or a user equipment, also may be a chip, a chip system, or a processor, etc., that supports the network device to implement the above method, further may be a chip, a chip system, or a processor, etc., that supports the user equipment to implement the above method. The device may be used to implement the method described in the above method embodiments, and reference may be made to the description in the above method embodiments for details.

The communication device 1200 may include one or more first processors 1201. The first processors 1201 may be a general-purpose processor or a special-purpose processor, etc., for example, may be a baseband processor or a central processing unit. The baseband processor may be configured to process communication protocols and communication data. The central processing unit may be configured to control a communication device (such as a base station, a baseband chip, a terminal device, a terminal device chip, a du (Distributed Unit) or a cu (Centralized Unit), etc.), to execute computer programs, and process computer program data.

Alternatively, the communication device 1200 may further include one or more first memories 1202, on which a computer program 1204 may be stored. The first processor 1201 executes the computer program 1204, thereby the communication device 1200 performs the method described in the above method embodiments. Alternatively, data may also be stored in the first memory 1202. The communication device 1200 and the first memory 1202 may be provided separately or integrated together.

Alternatively, the communication device 1200 may further include a transceiver 1205 and an antenna 1206. The transceiver 1205 may be referred to as a transceiver unit, a transceiver device, or a transceiver circuit, etc., and is configured to implement transceiver functions. The transceiver 1205 may include a receiver and a transmitter. The receiver may be referred to as a receiving device or a receiving circuit, etc., and is configured to implement a receiving function; the transmitter may be referred to as a transmitting device or a transmitting circuit, etc., and is configured to implement a transmitting function.

Alternatively, the communication device 1200 may further include one or more interface circuits 1207. The interface circuits 1207 are configured to receive code instructions and transmit the code instructions to the first processor 1201. The first processor 1201 runs the code instructions to cause the communication device 1200 to perform the method described in the above method embodiments.

In an implementation, the first processor 1201 may include a transceiver for implementing receiving and transmitting functions. For example, the transceiver may be a transceiver circuit, or an interface, or an interface circuit. The transceiver circuit, interface or interface circuit configured to implement the receiving and transmitting functions may be separate or integrated together. The above transceiver circuit, interface or interface circuit may be used for reading and writing codes/data, or the above transceiver circuit, interface or interface circuit may be used for transmitting or transferring signals.

In an implementation, the first processor 1201 may store a computer program 1203, which runs on the first processor 1201 to cause the communication device 1200 to perform the method described in the above method embodiments. The computer program 1203 may be solidified in the first processor 1201. In this case, the first processor 1201 may be implemented by hardware.

In an implementation, the communication device 1200 may include a circuit, which may implement the function of transmitting or receiving or communicating in the above method embodiments. The processor and transceiver described in the present disclosure may be implemented on an integrated circuit (IC), an analog IC, a radio frequency integrated circuit (RFIC), a mixed signal IC, an application specific integrated circuit (ASIC), a printed circuit board (PCB), an electronic device, etc. The processor and the transceiver may also be manufactured using various IC process technologies, such as a complementary metal oxide semiconductor (CMOS), an nMetal-oxide-semiconductor (NMOS), a positive channel metal oxide semiconductor (PMOS), a bipolar junction transistor (BJT), a bipolar CMOS (BiCMOS), a silicon germanium (SiGe), and a gallium arsenide (GaAs).

The communication device described in the above embodiments may be a network device or a user equipment, but the scope of the communication device described in the present disclosure is not limited here, and the structure of the communication device may not be limited to FIG. 12. The communication device may be a stand-alone device or part of a larger device. The communication device, for example, may be:

(1) a stand-alone integrated circuit (IC), or a chip, or a system or subsystem on chips;

(2) a set with one or more ICs, and alternatively, the IC set may further include a storage component configured to store data and computer programs;

(3) an ASIC, such as a modem;

(4) a module that can be embedded in other devices;

(5) a receiver, a terminal device, an intelligent terminal device, a cellular phone, a

wireless device, a handheld device, a mobile unit, a vehicle-mounted device, a network device, a cloud device, an artificial intelligence device, etc.; and

(6) others.

In a case where the communication device may be a chip or a chip system, reference may be made to a schematic structural diagram of the chip shown in FIG. 13. The chip shown in FIG. 13 includes a second processor 1301 and an interface 1302. There may be one or more second processors 1301, and there may be a plurality of interfaces 1302.

Alternatively, the chip further includes a second memory 1303, the second memory 1303 is configured to store necessary computer programs and data.

Those skilled in the art may also understand that the various illustrative logical blocks and steps listed in the embodiments of the present disclosure may be implemented by electronic hardware, computer software, or a combination of both. Whether such functionality is implemented through hardware or software depends on specific applications and the design requirements of the entire system. Those skilled in the art may use various methods to implement the functions for each specific application, but such implementation is not to be understood as exceeding the scope of protection of the embodiments of the present disclosure.

The present disclosure further provides a non-transitory readable storage medium having instructions stored thereon. The functions in any of the above method embodiments are implemented when the instructions are executed by a computer.

The present disclosure further provides a computer program product. The functions in any of the above method embodiments are implemented when the computer program product is executed by a computer.

All or part of the above embodiments may be implemented by software, hardware, firmware or any combination thereof. When implemented by software, all or part of the above embodiments may be implemented in the form of a computer program product which includes one or more computer programs. When the computer program is loaded and executed on a computer, the processes or functions described according to the embodiments of the present disclosure are generated in whole or in part. The computer may be a general-purpose computer, a special-purpose computer, a computer network, or other programmable device. The computer program may be stored in a non-transitory computer-readable storage medium, or transmitted from one non-transitory computer-readable storage medium to another non-transitory computer-readable storage medium. For example, the computer program may be transmitted from one website, computer, server or data center to another website, computer, server or data center by wired (e.g., coaxial cable, optical fiber, digital subscriber line (DSL)) or wireless (e.g., infrared, wireless, microwave, etc.) means. The non-transitory computer-readable storage medium may be any available medium that a computer can access or a data storage device such as a server or a data center that includes one or more available media integrated. The available medium may be a magnetic medium (e.g., a floppy disk, a hard disk, a magnetic tape), an optical medium (e.g., a high-density digital video disc (DVD)), or a semiconductor medium (e.g., a solid state disk (SSD)), etc.

Those of ordinary skill in the art may understand that the various numerical numbers such as first and second involved in the present disclosure are distinguished merely for the convenience of description and are not used to limit the scope of the embodiments of the present disclosure, and also indicate the order of precedence.

At least one in the present disclosure may also be described as one or more, and a plurality of may be two, three, four or more, which is not limited to the present disclosure. In the embodiments of the present disclosure, technical features in a technical feature are distinguished by “first”, “second”, “third”, “A”, “B”, “C”, “D”, etc., and there is no order of precedence or size between the technical features described by the “first”, “second”, “third”, “A”, “B”, “C” and “D”.

As used in the present disclosure, the terms “machine-readable medium” and “computer-readable medium” refer to any computer program product, device, and/or device (e.g., disk, optical disk, memory, programmable logic device (PLD)) for providing machine instructions and/or data to a programmable processor, including a machine-readable medium that receives machine instructions as machine-readable signals. The term “machine-readable signal” refers to any signal used to provide machine instructions and/or data to a programmable processor.

The system and techniques described in the present disclosure may be implemented in a computing system (e.g., as a data server) that includes back-end components, or a computing system (e.g., an application server) that includes middleware components, or a computing system (e.g., a user computer with a graphical user interface or a web browser through which a user may interact with implementations of the system and techniques described herein) that includes front-end components, or a computing system that includes any combination of such back-end components, middleware components, or front-end components. The components of the system may be interconnected by any form or medium of digital data communication (e.g., a communication network). Examples of communication networks include: a local area network (LAN), a wide area network (WAN), and the Internet.

A computer system may include a client and a server which are generally remote from each other and typically interact via a communication network. The relationship of the client and the server arises by running computer programs on respective computers that have a client-server relationship to each other.

It is to be understood that various forms of the processes shown above may be used, with steps reordered, added or deleted. For example, the various steps described in the present disclosure may be executed in parallel, sequentially, or in a different order, as long as the expected results of the technical solution disclosed in the present disclosure can be achieved, which is not limited here.

In addition, it is to be understood that the various embodiments described in the present disclosure may be implemented individually or in combination with other embodiments when the solution permits.

Those of ordinary skill in the art may appreciate that the units and algorithm steps of each example described in conjunction with the embodiments disclosed may be implemented by electronic hardware, or a combination of computer software and electronic hardware. Whether these functions are performed in hardware or software depends on specific applications and design constraints of the technical solution. Professional technicians may use different methods to implement the described functions for each specific application, but such implementation is not to be considered to be beyond the scope of the present disclosure.

Those skilled in the art may clearly understand that, for the convenience and brevity of description, specific working processes of the systems, devices and units described above may refer to corresponding processes in the above method embodiments and will not be repeated here.

The above description is merely a specific implementation of the present disclosure, but the scope of protection of the present disclosure is not limited here. Changes or substitutions that any technician familiar with the technical field may be readily conceivable of within the technical scope disclosed in the present disclosure shall be included in the scope of protection of the present disclosure. Therefore, the scope of protection of the present disclosure shall be based on the scope of protection of the claims.

1. A method for selecting a resource, performed by a first user equipment (UE), comprising:
receiving channel occupancy time (COT) sharing information from a second UE;
determining, based on at least one of the COT sharing information or a preset threshold, whether the first UE is capable of sharing a COT indicated in the COT sharing information;
determining, through resource-aware, a candidate resource set within a resource selection window in a time domain;
determining an available resource set from the candidate resource set, in response to determining that the first UE is incapable of sharing the COT based on the COT sharing information, wherein the available resource set comprises a resource from the candidate resource set that is not within the COT in the time domain; and
selecting the resource from the available resource set as a transmission resource of the first UE.

2. The method according to claim 1, wherein determining, based on at least one of the COT sharing information or the preset threshold, whether the first UE is capable of sharing the COT indicated in the COT sharing information comprises:
determining, based on the COT sharing information, a UE that is capable of sharing the COT; and
determining the first UE is incapable of sharing the COT indicated in the COT sharing information, in a case where the UE that is capable of sharing the COT does not comprise the first UE.

3. The method according to claim 1, wherein determining, based on at least one of the COT sharing information or the preset threshold, whether the first UE is capable of sharing the COT indicated in the COT sharing information comprises:
determining, based on the COT sharing information, a UE that is capable of sharing the COT;
determining whether a reference signal receiving power (RSRP) measured value of a physical sidelink channel corresponding to the COT sharing information is greater than a preset RSRP threshold, in a case where the UE that is capable of sharing the COT does not comprise the first UE; and
determining the first UE is incapable of sharing the COT indicated in the COT sharing information in a case where the RSRP measured value is greater than the preset RSRP threshold.

4. The method according to claim 1, wherein determining the available resource set from the candidate resource set comprises:
determining a time window of the COT based on a total length of the COT in the COT sharing information;
determining an overlapping time window between the resource selection window and the time window of the COT; and
determining, from the candidate resource set, a resource set that is not within the overlapping time window in the time domain as the available resource set.

5. The method according to claim 4, wherein determining the overlapping time window between the resource selection window and the time window of the COT comprises:
determining a later time between a start time of the resource selection window and a start time of the time window of the COT as a start time of the overlapping time window; and
determining an earlier time between an end time of the time window of the COT and an end time of the resource selection window as an end time of the overlapping time window.

6. A method for selecting a resource, performed by a first user equipment (UE), comprising:
determining, through resource-aware, a candidate resource set within a resource selection window in a time domain;
selecting a first resource from the candidate resource set;
receiving channel occupancy time (COT) sharing information from a second UE;
determining, based on the COT sharing information, whether the first resource at least partially overlaps with a second resource, wherein the second resource is a resource within a COT indicated in the COT sharing information, and the second UE allocates the second resource to a third UE through the COT sharing information; and
selecting a transmission resource of the first UE based on a priority of to-be-transmitted data of the first UE and a priority of to-be-transmitted data of the third UE, in response to determining that the first resource at least partially overlaps with the second resource.

7. The method according to claim 6, wherein selecting the transmission resource of the first UE based on the priority of the to-be-transmitted data of the first UE and the priority of the to-be-transmitted of the third UE comprises:
selecting the first resource as the transmission resource, in a case where the priority of the to-be-transmitted data of the first UE is greater than the priority of the to-be-transmitted data of the third UE.

8. The method according to claim 6, wherein selecting the transmission resource of the first UE based on the priority of the to-be-transmitted data of the first UE and the priority of the to-be-transmitted data of the third UE comprises:
determining an available resource set from the candidate resource set, in a case where the priority of the to-be-transmitted data of the first UE is less than the priority of the to-be-transmitted data of the third UE and the priority of the to-be-transmitted data of the third UE is greater than an occupation priority threshold, wherein the available resource set comprises a resource from the candidate resource set that is not within the COT in the time domain; and
selecting the resource from the available resource set as the transmission resource.

9. The method according to claim 8, wherein determining the available resource set from the candidate resource set comprises:
determining a time window of the COT based on a total length of the COT in the COT sharing information;
determining an overlapping time window between the resource selection window and the time window of the COT; and
determining, from the candidate resource set, a resource set that is not within the overlapping time window in the time domain as the available resource set.

10. The method according to claim 9, wherein determining the overlapping time window between the resource selection window and the time window of the COT comprises:
determining a later time between a start time of the resource selection window and a start time of the time window of the COT as a start time of the overlapping time window, and determining an earlier time between an end time of the time window of the COT and an end time of the resource selection window as an end time of the overlapping time window.

11-20. (canceled)

21. A communication device, comprising one or more processors and a memory,
wherein the memory stores a computer program, and the computer program stored in the memory, when collectively executed by the one or more processors, causes the communication device to:
receive channel occupancy time (COT) sharing information from a second UE;
determine, based on at least one of the COT sharing information or a preset threshold, whether the first UE is capable of sharing a COT indicated in the COT sharing information;
determine, through resource-aware, a candidate resource set within a resource selection window in a time domain;
determine an available resource set from the candidate resource set, in response to determining that the first UE is incapable of sharing the COT based on the COT sharing information, wherein the available resource set comprises a resource from the candidate resource set that is not within the COT in the time domain; and
select the resource from the available resource set as a transmission resource of the first UE.

22. A communication system comprising the first UE and a second UE, wherein the first UE is configured to perform the method according to claim 1.

23. A communication system comprising the first UE, the second UE, and the third UE, wherein the first UE is configured to perform the method according to claim 6.

24. A non-transitory computer storage medium storing computer-executable instructions, wherein the computer-executable instructions, when executed by a processor, cause the processor to implement the method according to claim 1.

25. The communication device according to claim 21, wherein the communication device is further configured to:
determine, based on the COT sharing information, a UE that is capable of sharing the COT; and
determine the first UE is incapable of sharing the COT indicated in the COT sharing information, in a case where the UE that is capable of sharing the COT does not comprise the first UE.

26. The communication device according to claim 21, wherein the communication device is further configured to:
determine, based on the COT sharing information, a UE that is capable of sharing the COT;
determine whether a reference signal receiving power (RSRP) measured value of a physical sidelink channel corresponding to the COT sharing information is greater than a preset RSRP threshold, in a case where the UE that is capable of sharing the COT does not comprise the first UE; and
determine the first UE is incapable of sharing the COT indicated in the COT sharing information in a case where the RSRP measured value is greater than the preset RSRP threshold.

27. The communication device according to claim 21, wherein the communication device is further configured to:
determine a time window of the COT based on a total length of the COT in the COT sharing information;
determine an overlapping time window between the resource selection window and the time window of the COT; and
determine, from the candidate resource set, a resource set that is not within the overlapping time window in the time domain as the available resource set.

28. The communication device according to claim 27, wherein the communication device is further configured to:
determine a later time between a start time of the resource selection window and a start time of the time window of the COT as a start time of the overlapping time window; and
determine an earlier time between an end time of the time window of the COT and an end time of the resource selection window as an end time of the overlapping time window.

29. A communication device comprising one or more processors and a memory, wherein the memory stores a computer program, and the computer program stored in the memory, when collectively executed by the one or more processors, causes the communication device to perform the method according to claim 6.
